(19) United States
(12) Patent Application Publication
(10) Pub. No.: US 2002/0138484 A1
(43) Pub. Date: Sep. 26, 2002

(54) Business method and data structure for eliminating non-value-added data activity across a business continuum

(76) Inventors: Gerald Christopher Bialek, Bloomfield Hills, MI (US); John Frederick Kramer, Brighton, MI (US); Peter Coote, Bloomfield, MI (US)

Correspondence Address: BROOKS & KUSHMAN P.C./FGTI, 1000 TOWN CENTER, 22ND FLOOR, SOUTHFIELD, MI, 48098, US

(21) Appl. No.: 09/681,361

(22) Filed: Mar. 26, 2001

(51) Int. Cl. G06F 17/60; G06F 7/00; G06F 17/30

(52) U.S. Cl. 707/8; 705/7

(57) ABSTRACT

A business method and data structure are provided for reducing non-value-added data activity across a plurality of distributed business departments. The business method comprises populating a data structure with data sets generated at each of the plurality of distributed business departments, eliminating data gaps, duplications and inconsistencies within the data structure, defining access, ownership, management, data source, data control and data dependencies attributes for each data set within the data structure, aligning each of the distributed business departments” business processes and corresponding data requirements to the data structure data sets based on the attributes defined for each data set, and updating the alignment in response to changes in the business processes and corresponding data requirements of the plurality of business departments as well as changes in the attributes defined for each data set.

### BACKGROUND OF INVENTION

This invention relates generally to database management and, more particularly, to a method and data structure for eliminating non-value-added data activity across a business continuum.

A business continuum comprises a plurality of departments or business entities (e.g., Accounting Department, Purchasing Department, Production Department, etc.) that cooperate as a business enterprise or corporation. Like many modern corporate environments, each member of the business continuum has a critical data requirement. For example, an accounting department requires a data set comprising accounting information (e.g., account numbers, itemized account data, balances, payer contact information etc.). A production department, on the other hand, requires a data set comprising production information (e.g., part numbers, part descriptions, bills of assembly, assembly instructions).

Generally, each business department maintains its own data set within data storage facilities accessible via a local area network (LAN). For example, the production department may access its local data set via a local area network wholly dedicated to the production department alone. Alternatively, the production department may maintain its data set on a portion of a wide area network, only that portion being dedicated to the production department—the remainder dedicated to other business continuum members or departments.

As a result of having a variety of data set storage arrangements available, data sets are often distributed across the business continuum in a variety of formats and locations. Additionally, each business continuum member may access its data according utilizing a proprietary or unique communication protocol.

Non-value-added data activity occurs across the business continuum as a result of the several data storage arrangements, storage formats and communication protocols. Non-value-added activity includes but is not limited to the redundant entry of data (i.e., more than one business continuum member inputs the same data), unnecessary data reconciliation (i.e., reconciling accounting data within the accounting data set with production data within the production data set), unnecessary data transformation (i.e., to purchase stock where the production department utilizes a stock numbering system that is different from that of the purchasing department) and the resolution of missing, inaccurate or inconsistent data among the distributed data sets.

Additionally, many data sets lack well-defined attributes including the owner or originator of the data within the data set, the person responsible for maintaining the data set and process controls or metrics for governing the input, update and general integrity of information within the data set.

Ultimately, benefactors of a business enterprise (e.g., customers, owners, shareholders, etc.) suffer from mismanaged data. Customers face higher prices to compensate for the non-value-added data activity, business owners generate lower profits, and shareholders receive lower dividends.

What is needed is a method and data structure for managing business data across a business continuum in a manner that minimizes non value-added data activity and thereby increases the efficiency and profitability of the overall business enterprise.

### SUMMARY OF INVENTION

One embodiment of the present invention is a business method for reducing non-value-added data activity across a plurality of distributed business departments. The business method comprises populating a data structure with data sets generated at each of the plurality of distributed business departments, eliminating data gaps, duplications and inconsistencies within the data structure, defining access, ownership, management, data source, data control and data dependencies attributes for each data set within the data structure, aligning each of the distributed business departments” business processes and corresponding data requirements to the data structure data sets based on the attributes defined for each data set, and updating the alignment in response to changes in the business processes and corresponding data requirements of the plurality of business departments as well as changes in the attributes defined for each data set.

Another embodiment of the present invention is a data structure embodied within a computer readable medium. The data structure comprises a plurality of data sets wherein each data set possesses the following attributes: (a) ownership for defining a name of a person or organization who owns content embodied within the data set; (b) membership for defining data items which make up the data set; (c) codification for defining terminology qualifying the data items which make up the data set; (d) source for defining the source of the data set; (e) management for defining a person or entity responsible for managing the data set; (f) access for defining which business entities may access the data set; and (g) control metrics for defining an integrity protocol for the data set.

### BRIEF DESCRIPTION OF DRAWINGS

FIG. 1 is a diagram graphically illustrating an example business continuum prior to the implementation of the present invention;FIG. 2 is a Venn diagram illustrating locations of non-value-added data activity across a business continuum;FIG. 3 is a block flow diagram illustrating a method for reducing non-value-added data activity in accord with the present invention;FIG. 4 is a block diagram illustrating example data sets that may be incorporated within a data structure in accord with the present invention;FIG. 5 is a block diagram illustrating example data set attributes in accord with the present invention;FIG. 6 is a graphical representation of a data structure comprising data sets having data gaps, duplications, inconsistencies and inaccuracies;FIG. 7 is a graphical representation of a data structure in which data gaps, duplications, inconsistencies and inaccuracies have been eliminated in accord with the present invention;FIG. 8 is a block diagram illustrating example business processes or departments in accord with the present invention;FIG. 9 is a Venn diagram illustrating a “point-in-time perspective”across a business continuum having a common data structure in accord with the present invention; andFIG. 10 is a Venn diagram illustrating a “time-span perspective”across a business continuum having a common data structure and a plurality of business processes in accord with the present invention.

### DETAILED DESCRIPTION

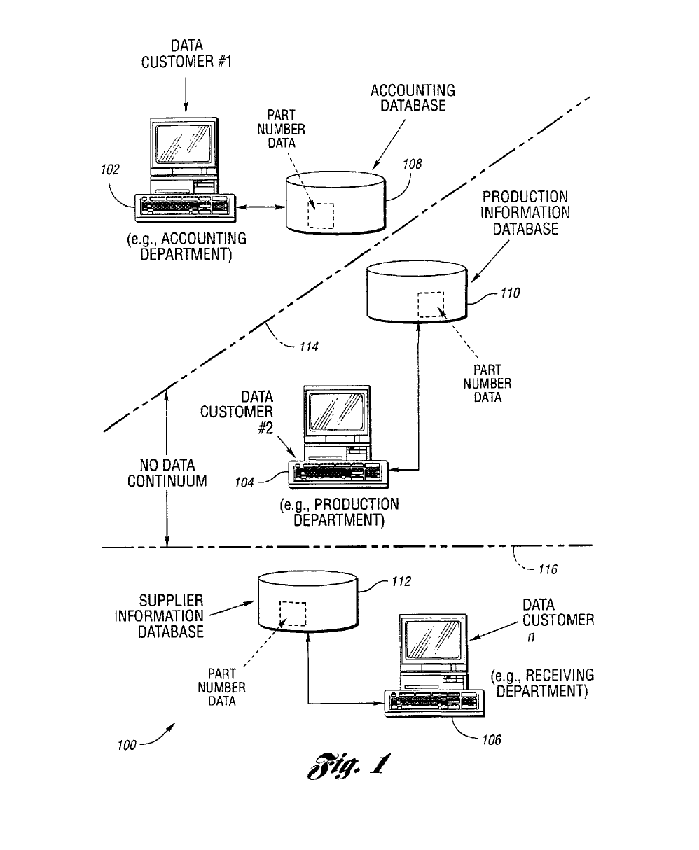

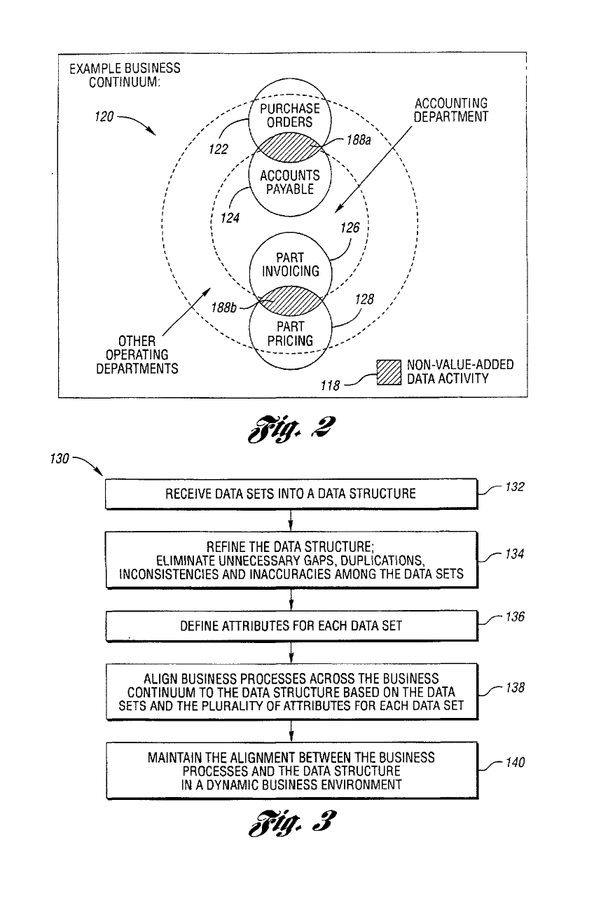

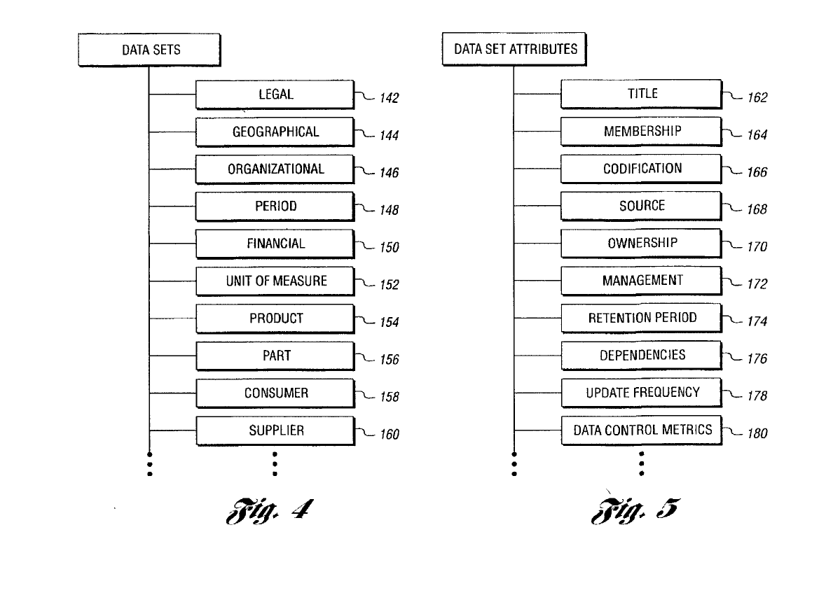

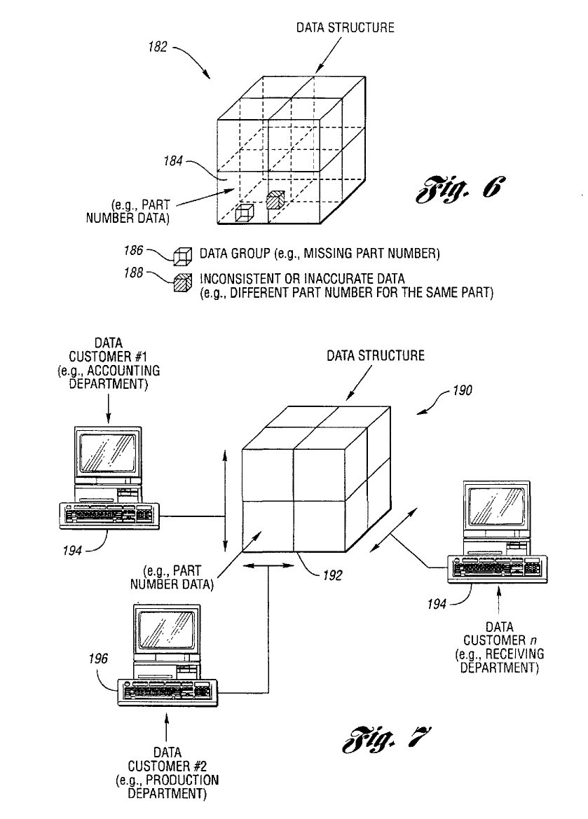

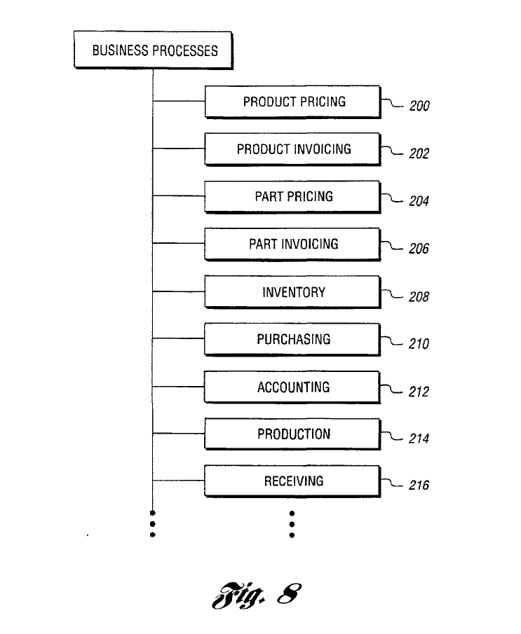

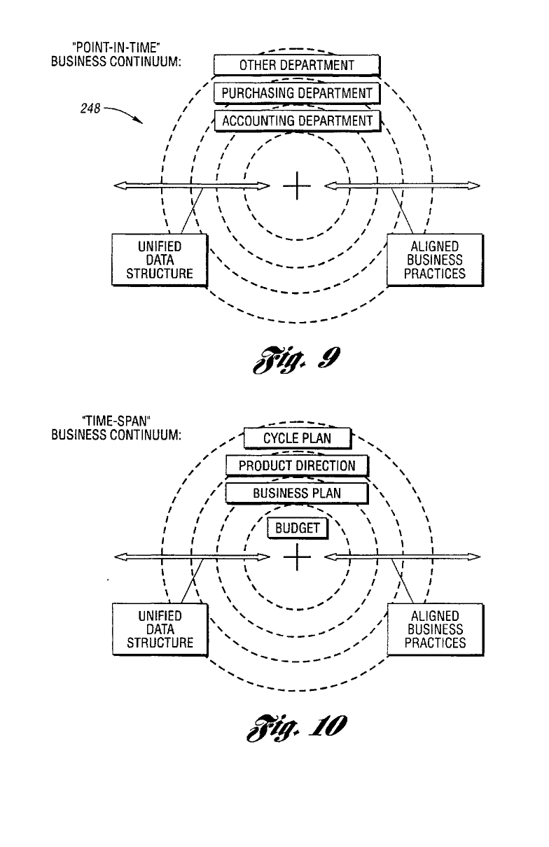

FIG. 1 graphically illustrates an example business environment 100 lacking the data structure management that the present invention provides. Generally, the business environment 100 comprises a plurality of data customers (e.g., Accounting Department 102, Production Department 104, Receiving Department 106 etc.). Each data customer accesses its respective data structure (e.g., Accounting Database 108, Production Information Database 110, Supplier Information Database 112 etc.) to input, update and retrieve information pertinent to its respective data requirements (e.g., accounting, receiving and production information).

Notably, no data continuum exists among the data structures 108, 110, and 112, as shown by dividing lines 114 and 116. For example, identical part number information may be redundantly input, updated and retrieved from several separate databases.

FIG. 2 is a Venn diagram illustrating locations of non-value-added data activity 118a and 118b across a business continuum 120 that lacks the data structure management the present invention provides. Because no data continuum exists across the business continuum 120 (i.e., among adjacent data customers as illustrated in FIG. 1), data-specific transactions (e.g., Purchase Orders 122, Accounts Payable 124, Vehicle Pricing 126, Vehicle Invoicing 128 etc.) involve unnecessary non-value-added data activity. Non-value-added data activities include but are not limited to redundant data entry, redundant data edits, data reconciliation, data transformation and the correction of inconsistencies or gaps that are generated as a result of the distributed data structures containing similar information.

FIG. 3 is a block flow diagram illustrating a preferred method 130 for reducing non-value-added data activity in accord with the present invention. The method comprises receiving input containing at least two data sets into a single data structure as represented by block 132, eliminating unnecessary data gaps, duplications, inconsistencies and inaccuracies within the data structure as represented by block 134, receiving input defining content, membership, ownership, management, source and data control attributes for each data set within the data structure as represented by block 136, aligning business processes across a business continuum to the data structure based on the data sets and the attributes for each data set as represented by block 138, and maintaining the alignment between the business processes and the data structure in a dynamic business environment as represented by block 140.

FIG. 4 is a block diagram illustrating example data sets that may be incorporated within a data structure in accord with the present invention. Data sets include but are not limited to legal 142, geographical 144 (e.g., market, plant, etc.), organizational 146 (e.g., business unit, department, etc.), period 148, financial 150, units of measure 152 (e.g., volume, weight, etc.), products 154, parts 156, consumers 158 (e.g., consumer definitions), and suppliers 160.

FIG. 5 is a block diagram illustrating example data set attributes in accord with the present invention.

The title attribute 162 defines the title for the data set.

The membership attribute 164 defines the data items or groups of data items that make up the data set. For example, the data set for a supplier would have membership attributes such as commodity, plant location, billing address, shipping address, procurement terms, etc.

The codification attribute 166 defines the terminology that describes or otherwise qualifies the data items or groups of data items that make up the data set. For example, given a data set representing “Market” (Country), codification could be represented using the three digit international ISO country code or a unique code being used within the business enterprise.

The source attribute 168 defines the person or entity from which the data set originated or the creator of the data set.

The ownership attribute 170 defines the person or entity who claims ownership of the data set.

The management attribute 172 defines the person or entity responsible for managing the data set. Data set management includes but is not limited to updating the data set, governing access to the data set and implementing the process metrics and controls described infra . Access to the data structure is governed by user id and password security, with different levels of access determined by the person or entity responsible for managing the data set.

The retention period attribute 174 defines the amount of time that the data structure includes the data set.

The dependencies attribute 176 defines the data customers who utilize the data set.

The update frequency attribute 178 defines the rate at which the data set is updated.

The data control metrics attribute 180 defines a protocol for ensuring the integrity of the data set. Preferably, every data set has an owner (gatekeeper) to ensure data integrity and customer satisfaction. The data control metrics are defined and maintained by the gatekeeper. The gatekeeper uses extremely rigorous data-gathering and statistical analysis to pinpoint sources of errors and ways of eliminating them. In addition, the gate keeper is responsible for defining and measuring critical to quality data characteristics.

FIG. 6 graphically illustrates an example data structure 182 comprising data sets (e.g. part number data 184) in accord with the present invention. Preferably, the data structure is operably embodied within one or more computer-readable mediums such as magnetic hard or floppy disc, magnetic tape, random access memory, read only memory, etc. Computer-readable mediums and their operable interconnection in accord with the present invention are well known in the art of data structure development and management.

It is additionally preferred that the data structure 182 be operably accessible by data processing systems, software applications and operating systems, the accessibility also well known in the art.

Notably, the data structure contains data gaps 182, duplications, inconsistencies and inaccuracies 188. For example, a given part number may be redundantly received within the data structure in more than one location. The part number for a given item may be listed inaccurately, or not listed at all. Additionally, an inaccurate part number for a given item may be received into the data structure (i.e., inconsistent or inaccurate data) or not received into the data structure at all (i.e., a data gap).

FIG. 7 graphically illustrates a refined data structure 190 comprising a plurality of data sets (i.e., part number data 192) in which the data gaps, duplications, inconsistencies and inaccuracies have been eliminated in accord with the present invention. Notably, the data structure serves as the sole information repository across an entire business continuum (i.e. Accounting Department-Production Department-Receiving Department etc.). When more that one source of data exists determination of the one best source is required. Preferably, this source is used by the business enterprise and all other sources are eliminated.

As indicatedfor illustrative purposes only, part numbers are all contained within the data structure in a single location. This aspect of the present invention can be contrasted with FIG. 1 in which given information (e.g., part number information) is redundantly stored across the business continuum in a plurality of locations.

Essentially, the data structure provides a transparent data continuum across the business continuum. Preferably, all data sets included within the data structure are transparently aligned with the business processes of each data customer (e.g., the Accounting Department 194, the Production Department 196, the Receiving Department 198 etc.) for the efficient input, update and retrieval of information.

FIG. 8 is a block diagram illustrating an example set of business processes to which the data structure may be aligned with in accord with the present invention. Business processes include but are not limited to product pricing 200, product invoicing 202, part pricing 204, part invoicing 206, inventory 208, purchasing 210, accounting 212, production 214 and receiving 216.

FIG. 9 is a Venn diagram 218 illustrating a “point-in-time perspective”across a business continuum having a common data structure. Notably, data customer processes are aligned to the aligned data structure. Alignment occurs when a common language is used and the need for translation over the time continuum is eliminated.

FIG. 10 is a Venn diagram 220 illustrating a “time-span perspective” across a business continuum having a common data structure and a plurality of business processes (e.g., Cycle Plan, Product Direction, Business Plan, Budget, Forecast, Actuals, etc.). Notably, data customer processes are aligned to the aligned data structure. As a result, data definitions (e.g., Part Number Definitions) remain consistent across the plurality of business processes within the business continuum.

While the best mode for carrying out the invention has been described in detail, those familiar with the art to which this invention relates will recognize various alternative designs and embodiments for practicing the invention as defined by the following claims.

1. A business method for reducing non-value-added data activity across a plurality of distributed business departments, the method comprising:
populating a data structure with data sets generated at each of the plurality of distributed business departments;
eliminating data gaps, duplications and inconsistencies within the data structure;
defining access, ownership, management, data source, data control and data dependencies attributes for each data set within the data structure;
aligning each of the distributed business departments” business processes and corresponding data requirements to the data structure data sets based on the attributes defined for each data set; and
updating the alignment in response to changes in the business processes and corresponding data requirements of the plurality of business departments as well as changes in the attributes defined for each data set.

2. The method of claim 1 additionally comprising compiling a glossary summarizing the data sets and corresponding attributes wherein the glossary is provided to the plurality of distributed business departments to facilitate the step of aligning each of the distributed business departments” business processes and corresponding data requirements to the data structure.

3. The method of claim 1 additionally comprising defining a retention period attribute for a data set wherein the data set is deleted from the data structure upon expiration of the defined retention period.

4.The method of claim 1 additionally comprising the steps of defining an update frequency for a data set and updating content and attributes for the data set according to the defined update frequency.

5. A data structure embodied within a computer readable medium, the data structure comprising a plurality of data sets wherein each data set possesses the following attributes:
(a)ownership for defining a name of a person or organization who owns content embodied within the data set;
(b)membership for defining data items which make up the data set;
(c)codification for defining terminology qualifying the data items which make up the data set;
(d)source for defining the source of the data set;
(e)management for defining a person or entity responsible for managing the data set;
(f)access for defining which business entities may access the data set; and
(g)control metrics for defining an integrity protocol for the data set.

6. The data structure of claim 5 wherein each data set additionally possesses a retention period attribute for defining the amount of time that the data set is to be retained within the data structure.

7. The data structure of claim 5 wherein each data set additionally possesses a dependents attribute for defining distributed business departments who require data items within the data set to carry out their respective business processes.

8. The data structure of claim 7 wherein each data set additionally possesses an update frequency attribute for defining the rate at which the data set is to be updated.
